(19) United States
(12) Patent Application Publication
(10) Pub. No.: US 2007/0040350 A1
(43) Pub. Date: Feb. 22, 2007

(54) Recumbent trike

(76) Inventors: John R. Wiswell, Hastings, MI (US); Randall M. Bertrand, Hastings, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/486,767

(22) Filed: Jul. 14, 2006

Related U.S. Application Data
(60) Provisional application No. 60/709,688, filed on Aug. 19, 2005.

(51) Int. Cl. B62K 7/00

(52) U.S. Cl. 280/259; 280/282

(57) ABSTRACT

A recumbent trike includes a frame constructed of metal or carbon fiber tubes that are interconnected by metal fittings. The frame includes a pair of main tubes extending front to rear that provide a very stiff and lightweight structure that is relatively stiff when subject to side loads generated in turns, yet relatively flexible when subject to vertical loads caused by bumps in a road surface, thereby enhancing rider enjoyment. A seat is adjustably supported on the main tubes, to provide for fore-aft adjustment to accommodate riders having a wide range of heights. The back support portion of the seat is also adjustably connected to the frame to provide for greater or smaller recline angle. The drive chain extends through one of the main tubes of the frame, such that external chain guides or supports are not required.

### CROSS-REFERENCE TO RELATED APPLICATION

The present application claims the benefit of U.S. Provisional Application No. 60/709,688, filed on Aug. 19, 2005, the entire contents of which is hereby incorporated by reference.

### BACKGROUND OF THE INVENTION

A variety of human-powered recumbent tricycles or “trikes” have been developed. One type of recumbent trike includes a pair of front wheels, and a single rear wheel. The crank is positioned at the front of the trike, and drives the rear wheel via an elongated chain. Known trike designs may include a metal frame including steel or aluminum tubes that are welded together. Such frames may include a single main frame tube that extends from the front portion of the trike to the chain stays at the rear portion of the frame.

### SUMMARY OF THE INVENTION

One aspect of the present invention is a human powered three-wheeled vehicle including a frame having a forward portion and a rear portion. The frame also includes at least two side-by-side tubular frame members extending between the forward portion of the frame and the rear portion of the frame. A pair of front wheels are mounted to the frame adjacent the forward portion thereof, and a rear wheel is mounted to the frame adjacent the rear portion thereof. A cog is connected to the rear wheel, and a crank including a chain wheel is mounted to the frame adjacent the front portion thereof. A drive chain wraps around the chain wheel and the cog and extends therebetween and drives the rear wheel upon rotation of the crank. A seat is mounted to the frame for supporting a rider in a recumbent position.

Another aspect of the present invention is a human powered three-wheeled vehicle including a frame having a forward portion, a rear portion, and a central portion having at least two side-by-side tubular frame members extending between the forward portion of the frame and the rear portion of the frame. At least a first one of the tubular frame members defines an elongated internal passageway with openings to the passageway at forward and rear end portions of the first tubular frame member. A pair of front wheels are mounted to the frame adjacent the forward portion thereof, and a rear wheel is mounted to the frame adjacent the rear portion thereof. A cog is connected to the rear wheel, and a crank including a chain is mounted to the frame adjacent the front portion thereof. The vehicle further includes a drive chain that is wrapped around the chain wheel and the cog and extends therebetween and drives the rear wheel upon rotation of the crank. The elongated loop includes first and second elongated chain portions, wherein the first elongated chain portion extends inside the first one of the tubular frame members. A seat is mounted to the frame for supporting a rider in a recumbent position.

Another aspect of the present invention is a human powered three-wheeled vehicle including a frame having a forward portion and a rearward portion, and an elongated central portion extending between the forward and rearward portions of the frame. The central portion of the frame defines a side-to-side bending stiffness about a vertical plane, and a vertical bending stiffness about a horizontal plane. The side-to-side bending stiffness is substantially greater than the vertical bending stiffness. The forward portion of the frame includes left and right outrigger members extending horizontally outward and defining outer ends. The vehicle further includes a pair of front wheels rotatably mounted to the outer ends of the left and right outrigger members. The front wheels are pivotable to provide steering for the vehicle. A rear wheel is rotatably mounted to the rear portion of the frame, and a rear drive member is connected to the rear wheel. A crank including a forward drive member is mounted to the forward portion of the frame, and an elongated drive member engages the forward drive member and the rear drive member and moves the rear drive member upon movement of the forward drive member. A seat is mounted to the central portion of the frame for supporting a rider.

### BRIEF DESCRIPTION OF THE DRAWINGS

FIG. 1 is a perspective view of a trike according to one aspect of the present invention;

FIG. 2 is a perspective view of the trike of FIG. 1 from a different viewing angle;

FIG. 3 is a perspective view of the frame of the trike of FIG. 1;

FIG. 4 is a perspective view of the trike frame from a different viewing angle;

FIG. 5 is a partially fragmentary, perspective view of the adjustable lower seat-to-frame connection;

FIG. 6 is a partially schematic, fragmentary, cross-sectional view of a main tube of the frame showing the routing of a portion of the drive chain through the frame tube;

FIG. 7 is a top view of a front main intersection fitting of the frame of the trike of FIG. 1;

FIG. 8 is a front elevational view of the front main intersection fitting of FIG. 7;

FIG. 9 is a side elevational view of the front main intersection fitting of FIG. 7;

FIG. 10 is a top view of the rear main intersection fitting of FIG. 7;

FIG. 11 is a front elevational view of the rear main intersection fitting of FIG. 10;

FIG. 12 is a side elevational view of the rear main intersection fitting of FIG. 10;

FIG. 13 is a front elevational view of an intersection fitting that mounts the crank and interconnects the front frame tube and upright front derailleur support tube;

FIG. 14 is a side elevational view of the intersection fitting of FIG. 13; and

FIG. 15 is a perspective view of an end cap that provides for adjustable mounting of the front wheels and steering components to the frame.

### DETAILED DESCRIPTION OF PREFERRED EMBODIMENT

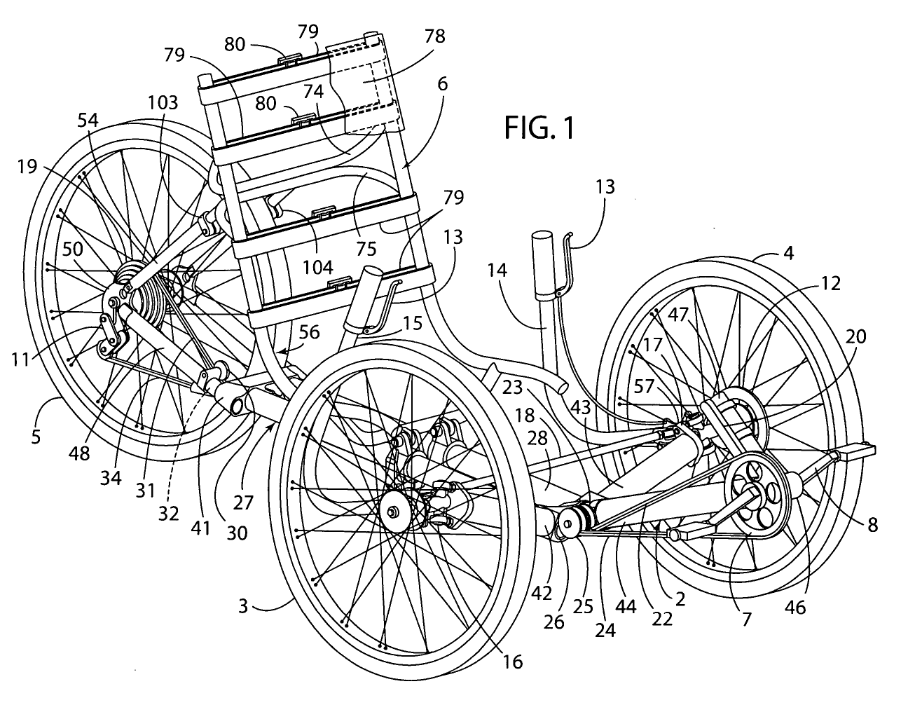

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

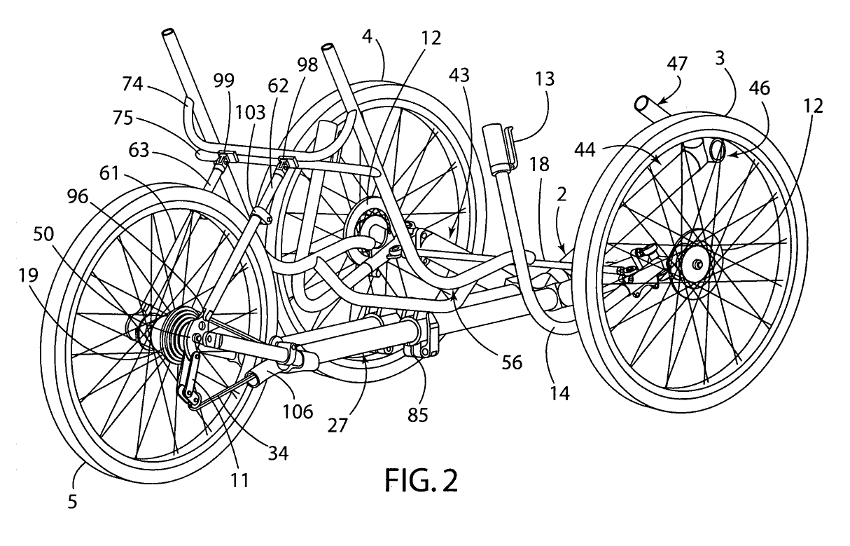

With reference to FIGS. 1 and 2, a recumbent trike 1 according to one aspect of the present invention includes a frame 2, a pair of front wheels 3 and 4, and a rear wheel 5. A seat 6 is adjustably mounted to the frame 2, and supports a rider in a recumbent position.

As discussed in more detail below, the frame 2 includes carbon fiber composite tubes that are rigidly interconnected by metal fittings. The use of carbon fiber tubes and metal fittings provides a very stiff and lightweight frame structure that is relatively economical to fabricate. Furthermore, the carbon fiber tubing absorbs vibrations and bumps, and thereby provides a more comfortable ride.

Another aspect of frame 2, also discussed in more detail below, is the dual, side-by-side main frame tubes 27 and 28 that extend under the seat 6 to provide a rigid “backbone” for the frame 2. Because of tubes 27 and 28, frame 2 is very stiff in bending and torsion resulting from cornering and the like. However, tubes 27 and 28 have substantially less stiffness in bending resulting from vertical loads caused by bumps and the like of a road surface. Thus, frame 2 has substantial stiffness in cornering situations to thereby provide more precise control and enhanced steering “feel”, and also provides a comfortable ride by flexing vertically to absorb the impact of bumps and the like.

A chain wheel 7 and crank 8 of a known design that is substantially the same as utilized in multi-speed bicycles is mounted to the front end 9 of frame 2. A front derailleur 20 of a known design provides for gear changes at chain wheel 7.

An elongated drive chain 10 wraps around and operably engages the chain wheel 7 to drive the rear wheel 5 via a multi-gear sprocket 19 of a known design that is substantially the same as those used for multi-speed bicycles. A rear derailleur 11 of a known design provides for gear changes at multi-gear sprocket 19. As discussed in more detail below, a central portion of drive chain 10 extends through frame tube 27 from the front portion of trike 1 to the rear portion of trike 1. Routing of chain 10 within frame tube 27 provides a smooth, unobstructed outer surface of frame tube 27, thereby permitting a wide range of adjustment of seat 6. Also, routing chain 10 within frame tube 27 reduces the likelihood of chain 10 contacting objects during use or storage that may otherwise damage chain 10. Furthermore, the appearance of trike 1 is substantially less cluttered, and more aesthetically pleasing due to routing of chain 10 inside of frame tube 27.

A first portion 22 of drive chain 10 extends from the chain wheel 7 to a first idler pulley 23 that is rotatably mounted to the frame, and a second portion 24 of drive chain 10 extends from chain wheel 7 to a second idler pulley 25 that is also rotatably mounted to the frame. The chain portions 22 and 24 extend into an opening 26, through first main frame tube 27, and around rear sprocket 19 and rear derailleur 11. A third idler pulley 30 guides upper rear chain portion 31 as it exits from opening 32, and a tubular Teflon member 33 extends outwardly from opening 32 and guides a lower rear chain portion 34.

Trike 1 also includes disc brakes 12 are operably connected to the front wheels 3 and 4. The disc brakes 12 are of a known design, and are operated by movable brake levers 13 mounted to steering arms 14 and 15. The steering arms 14 and 15 are operably connected to the front wheels 3 and 4 to thereby pivot the front wheels 3 and 4 about king pins 16 and 17, and a steering cross bar 18 is operably connected to the steering arms 14 and 15 to maintain proper alignment of the front wheels 3 and 4 relative to one another. The steering arrangement, including steering arms 14 and 15 and cross bar 18 is generally known in the art. However, as discussed in more detail below, the king pins 16 and 17 are mounted via a unique adjustable arrangement that provides for camber adjustment of the front wheels 3 and 4 to provide for various operating conditions and/or user preferences.

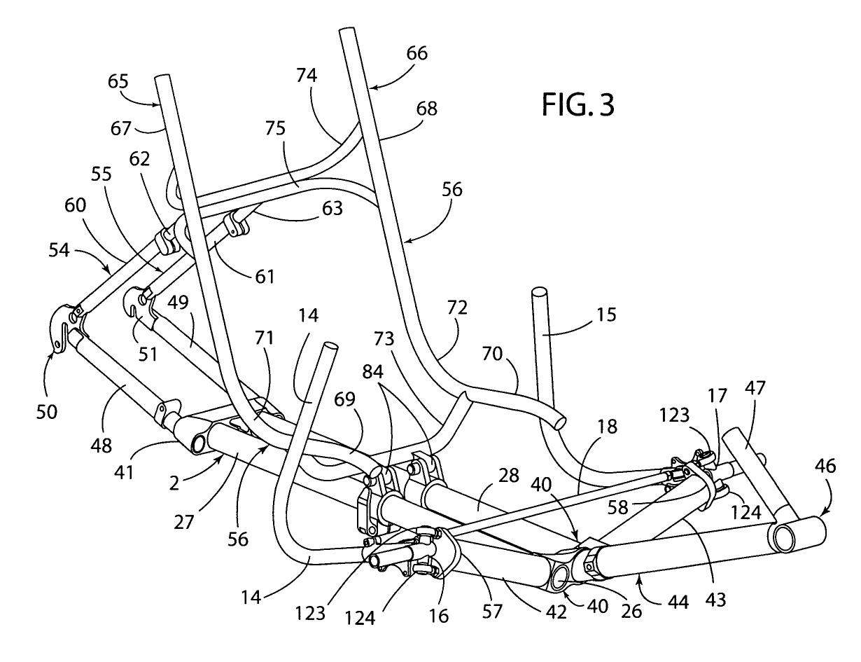

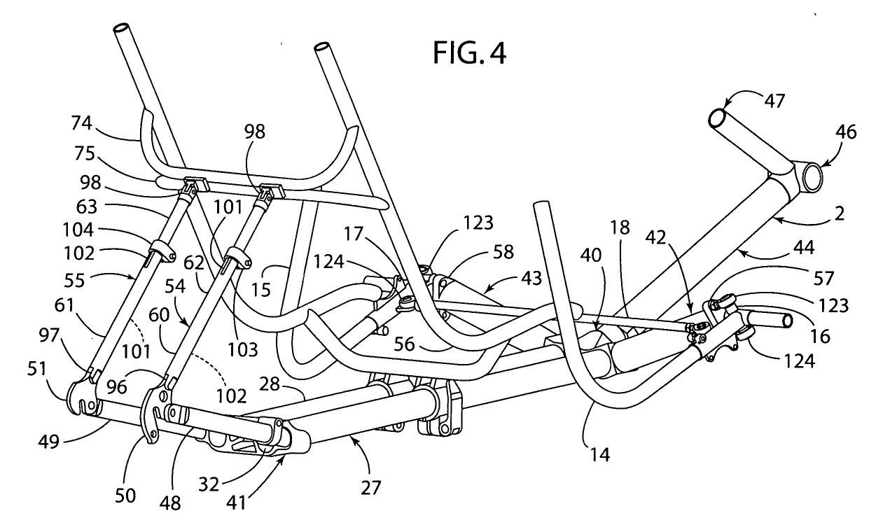

With further reference to FIGS. 3 and 4, frame 2 includes a pair of parallel main frame tubes 27 and 28 that extend front to rear. A front intersection fitting 40 and a rear intersection fitting 41 are made of 6061 aluminum or other suitable material, and rigidly interconnect the carbon fiber composite frame tubes 27 and 28. First and second carbon fiber composite outrigger tubes 42 and 43 extend upwardly and outwardly from front intersection fitting 40, and a carbon fiber composite front tube 44 extends forwardly and upwardly from front intersection fitting 40. A front fitting 46 is secured to the front tube 44, and supports an upwardly and rearwardly extending tube 47 that provides for mounting of the front derailleur 20 when the recumbent trike 1 is assembled. Carbon fiber composite chain stays 48 and 49 are rigidly secured to the rear intersection fitting 41, and to aluminum drop outs 50 and 51. Drop outs 50 and 51 provide for mounting of a conventional bicycle quick release rear wheel 5. Seat stays 54 and 55 extend upwardly from drop outs 50 and 51. As discussed in more detail below, seat stays 54 and 55 adjustably support seat frame 56. The seat stays 54 and 55 each include an outer tube 60 and 61, respectively, and a smaller diameter inner tube 62 and 63, respectively that is telescopically received in the larger tubes 60 and 61. End fittings 57 and 58 at the outer ends of outrigger tubes 42 and 43, respectively, provide for mounting of king pins 16 and 17, brakes 12, and front wheels 3 and 4.

Seat frame 56 includes a pair of tubular aluminum outer frame members 65 and 66 that include upper or back portions 67 and 68, and forwardly extending seat portions 69 and 70, with curved portions 71 and 72 extending between the upper portions 67 and 68 and lower portions 69 and 70. A lower cross frame member 73, and a pair of upper cross frame members 74 and 75 extend between and interconnect the outer frame members 65 and 66. The outer frame members 65 and 66, and the cross frame members 73, 74 and 75 of the seat frame 56 are made of tubular aluminum, and the cross frame members 73, 74 and 75 are welded to the outer frame members 65 and 66. With reference back to FIG. 1, a cloth seat web 78 extends between the outer frame members 65 and 66, and provides support for the rider. A plurality of adjustable nylon straps 79 with buckles or latches 80 extend between the outer frame members 65 and 66, and provide support for the rider. The latches 80 are commercially available units of a known design, and provide for adjustment of the length of the nylon straps 79 to permit the rider to adjust the amount of support at various positions of the seat 6. When assembled, the nylon straps 79 and latches 80 are positioned under (or in back of) cloth or mesh 78.

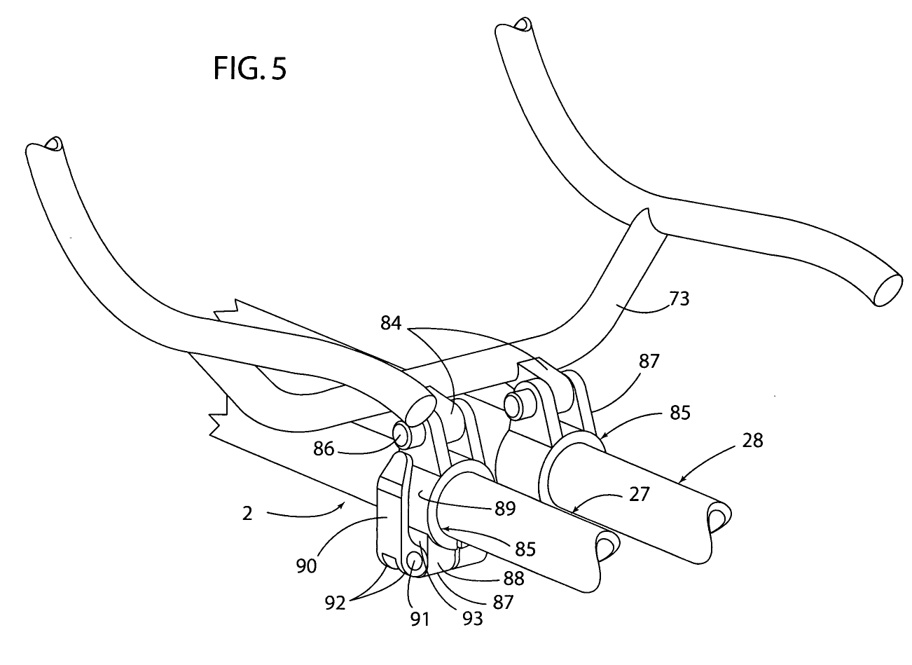

With further reference to FIG. 5, a pair of tabs 84 are welded to the transverse seat frame member 73, and extend downwardly and forwardly from the transverse seat frame member 73. A pair of clamps 85 are pivotally connected to the tabs 84 via a threaded fastener 86, pin, or the like that forms a clevis-like pivoting interconnection between the clamps 85 and tabs 84. The body portions 87 of clamps 85 are made of a polymer material, and have a C-shape with a pair of arm portions 88, 89 extending around main tubes 27 and 28. A clamp arm 90 includes a pivot pin 91, and cam surfaces 92 that bear against an end surface 93 to thereby clamp arm portions 88 and 89 of clamp body 87 to the main tubes 27 and 28. Clamps 85 are commercially available components previously utilized to provide for height adjustment of musical instruments such as drums. Rotation of the clamp arm 90 provides for quick and easy clamping and unclamping of the seat 6 to provide fore-aft adjustment in infinitesimally small increments. Positioning drive chain 10 through tube 27 permits a large range of adjustment of the position of seat 6 because there are no external chain support pulleys or the like that would otherwise limit movement of clamps 85 along tubes 27 and 28. Because the tubes 27 and 28 are substantially unobstructed along their entire length, the clamps 85 can be positioned along a very large portion of main tube 27 without obstruction. Also, because the main tubes 27 and 28 are spaced apart, side forces resulting from the driver's weight in a turn are largely absorbed by the frame 2 as a couple including an upward force on one of the main tubes 27 or 28, and a downward force on the other of the main tubes 27 or 28. In contrast, prior known trike frames utilizing a single main tube generally experience a large torsional load on the main tube. The stiffness of prior frames due to this type of loading in corners is substantially less than the two main tube construction of the frame 2 of the trike 1 of the present application.

With reference back to FIG. 4, the seat stays 54 and 55 extend upwardly from the drop outs 50 and 51, and interconnect with the upper cross seat frame members 74 and 75. The outer tubes 60 and 61 are connected to drop outs 50 and 51 by lower pivots 96 and 97, and the inner tubes 62 and 63 are pivotally connected to the cross seat frame members 74 and 75 by upper pivot connections 98 and 99. The outer tubes 60 and 61 include slots 101 and 102, respectively, adjacent clamps 103 and 104. The clamps 103 and 104 are secured to the upper ends of the outer tubes 60 and 61, and include a threaded fastener such as an Allan bolt that can be tightened to clamp the outer tube 60 to inner tube 62, and to clamp outer tube 61 to inner tube 63 at a desired position. The slots 101 and 102 provide for contraction of the outer tubes 60 and 61 as the fastener is tightened to secure clamps 103 and 104. It will be understood that clamps 103 and 104 are similar to clamps commonly utilized to provide for height adjustment of a conventional bicycle seat. The telescoping seat stays 54 and 55 thereby provide tilt adjustment and fore-aft adjustment of the back rest portion 76 of seat 6. The clamps 85 to the main frame tubes 27 and 28 and the telescoping seat stays 54 and 55 provide for a very wide range of adjustment of the seat 6 to thereby accommodate users of greatly varying size. Also, the telescoping seat stays 54 and 55 provide for infinitesimally small adjustments, and permit adjustment of the seat angle to a more or less reclined position as desired by the rider. The pivotable connections of seat stays 54 and 55, and pivots formed by fastener 86 permit tilting of the seat 6 through a wide range of angular positions.

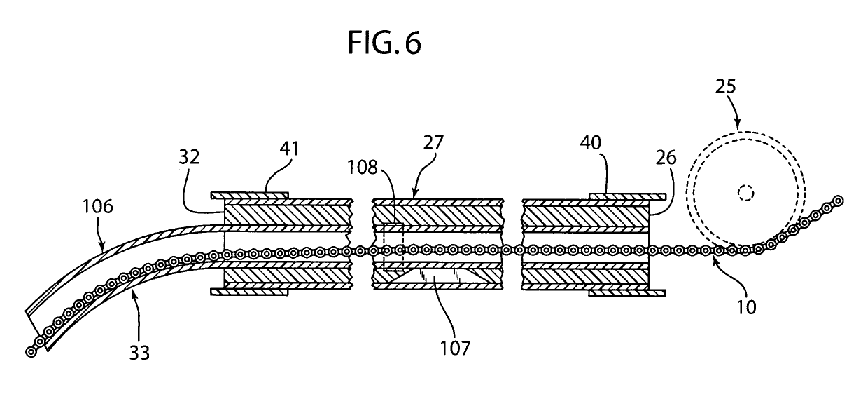

As discussed above in connection with FIG. 1, the drive chain 10 extends through main frame tube 27, and is positioned and guided by first and second idler pulleys 23 and 24 adjacent front opening 26 in front intersection fitting 40 at the front of main tube 27, and chain 10 is guided by a third idler pulley 30 and a Teflon® sheath or tube 33 adjacent the opening 32 in rear intersection 41 at the rear end of main tube 27. With further reference to FIG. 6, Teflon® tube 33 is mounted inside of main tube 27, and extends along the length of the tube 27. An end portion 106 of Teflon® tube 33 extends outwardly from the opening 32, and curves downwardly to guide lower rear chain section 34 towards the derailleur 11. The curved portion 106 of Teflon® tube 33 is curved by heating the portion 106 of tube 33, and bending the portion 106 to permanently deform it into a curved shape. One or more blocks or ramps 107 that are also made of Teflon® or other low-friction material are adhesively bonded inside of frame tube 27 and support Teflon® tube 33 at the center portion thereof. One or more Teflon® tie straps 108 are tightly secured around Teflon® tube 33, and “Great Stuff”™ foam sealant 109 is positioned around Teflon® tube 33 and tie strap 108 to support tube 33. The idler pulley 25 is positioned to guide the chain 10 into the center of the Teflon® tube 33, such that the chain 10 does not contact the inner side walls of the Teflon® tube 33 (except at curved portion 106 ) to an appreciable degree when chain 10 is under tension. A second Teflon® tube (not shown) that is substantially similar to Teflon® tube 33 is also positioned inside main tube 27 directly to the side of Teflon® tube 33, and supported by ramp 107 to guide the portion of drive chain 10 that extends from idler pulley 23 to idler pulley 30. The second Teflon® tube is substantially similar to Teflon® tube 33, except that it does not include an extension 106 extending from opening 32. Rather, the idler pulleys 23 and 30 position the chain in the second Teflon® tube, such that the chain does not contact the second Teflon® tube when the chain section is taut or under tension. According to a preferred arrangement, tube 33 may be angled slightly within frame tube 27, such that the rear portion of tube 33 contacts the bottom inner sidewall of frame tube 27 at opening 32, and the front portion of tube 33 contacts the top inner sidewall of tube 27 at opening 26 to thereby align tube 33 with chain 10. Also, the second Teflon® tube (not shown) may be positioned to angle in the opposite direction, with a rearward end of the second Teflon® tube contacting the top inner sidewall of frame tube 27 at opening 32, and forward end of the second Teflon® tube contacts the top inner sidewall of frame tube 27 at opening 26 to align the second Teflon® contacts the top inner sidewall of frame tube 27 at opening 26 to align the second Teflon® tube with the other section of drive chain 10. Foam 109 supports the Teflon® tubes in the angled position. It will be understood that other low friction materials such as nylon and other sheath or guide configurations could also be utilized for guiding chain 10 within frame tube 27.

As discussed above in connection with FIGS. 3 and 4, frame 2 includes carbon fiber main tubes 27 and 28, carbon fiber outrigger tubes 42 and 43, a carbon fiber front tube 44, carbon fiber upward tube 47, and carbon fiber chain stays 48 and 49. The carbon fiber tubes are interconnected by aluminum fittings or intersections 40, 41 and 46, and aluminum end fittings 57 and 58 provide for mounting of front wheels 3 and 4 and steering components. The carbon fiber tubes may be constructed utilizing a suitable carbon fiber material and resin matrix formed on a mandrel and cured according to known techniques. The orientation and number of layers of material can be varied to provide a range of stiffness, strength, and other such characteristics as required for a particular trike 1. Also, non-tubular frame components could also be utilized instead of one or more of the tubes. Although the length, diameter, wall thickness and cross-sectional shapes may be varied, the following chart shows examples of the dimensions of the tubes:

| Tube | O.D. (inches) | I.D. (inches) | Length (inches) |
|---|---|---|---|
| Main Tubes 27, 28 | 1.50 | 1.25 | 29.00 |
| Front Lower Tube 44 | 1.75 | 1.50 | 8.00 |
| Front Upper Tube 47 | 1.13 | 1.00 | 5.50 |
| Outrigger Tubes 42, 43 | 1.75 | 1.50 | 18.50 |
| Chain Stays | 1.00 | 0.810 | 10.00 |

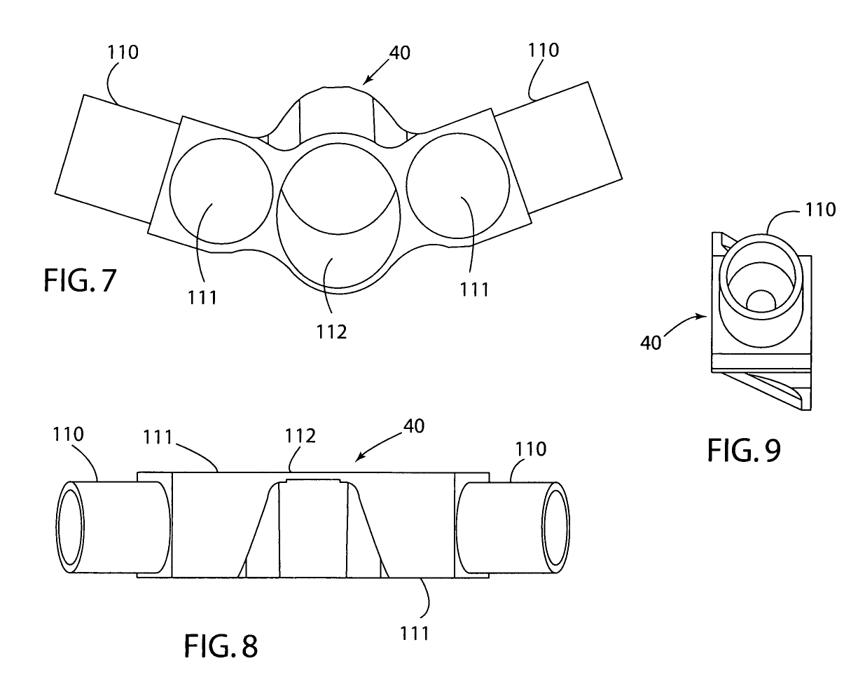

With reference to FIGS. 7 and 8, front intersection fitting 40 is made of a metal material such as 6061 aluminum, and includes cylindrical extensions 110 configured to fit closely inside of the ends of outrigger tubes 42 and 43. A pair of cylindrical openings 111 receive the forward ends of main tubes 27 and 28, and a cylindrical center opening 112 receives the lower rear end of forward tube 44. The tubes are bonded to the front intersection fitting 40 utilizing a suitable adhesive such as Loctite® Hysol® adhesive. The gap between the tubes and the fittings is selected to ensure a strong adhesive bond.

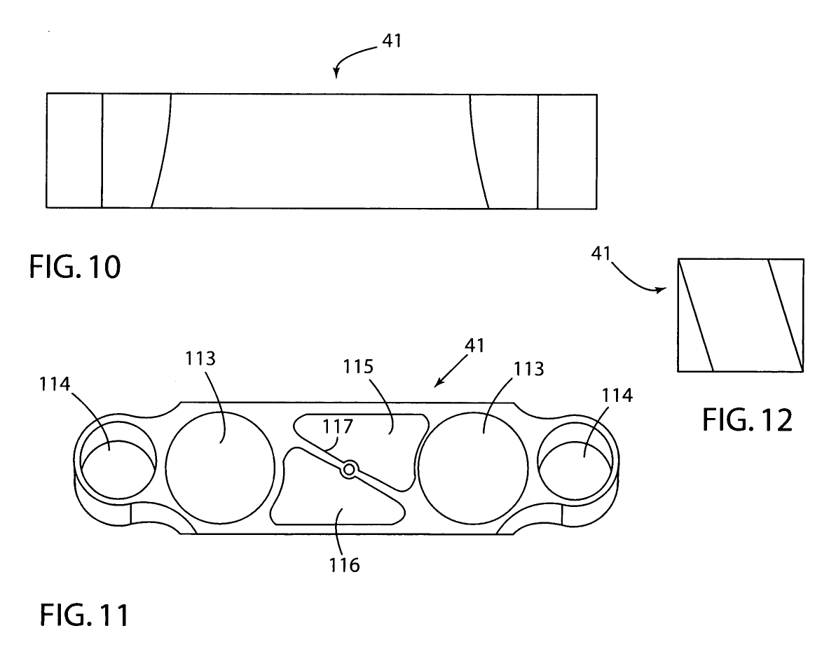

With further reference to FIGS. 10-12, rear intersection 41 is also machined of 6061 aluminum or other suitable material. The fitting 41 includes a pair of openings 113 that receive the rear ends of main tubes 27 and 28, and a pair of smaller openings 114 that receive the ends of chain stays 48 and 49. Clearance openings 115 and 116 reduce the weight of fitting 41, and a gusset 117 extends between the openings 115 and 116, and stiffens and strengthens the fitting 41. Tubes 27, 28, 48 and 49 are adhesively bonded to fitting 41 utilizing Loctite® Hysol® adhesive.

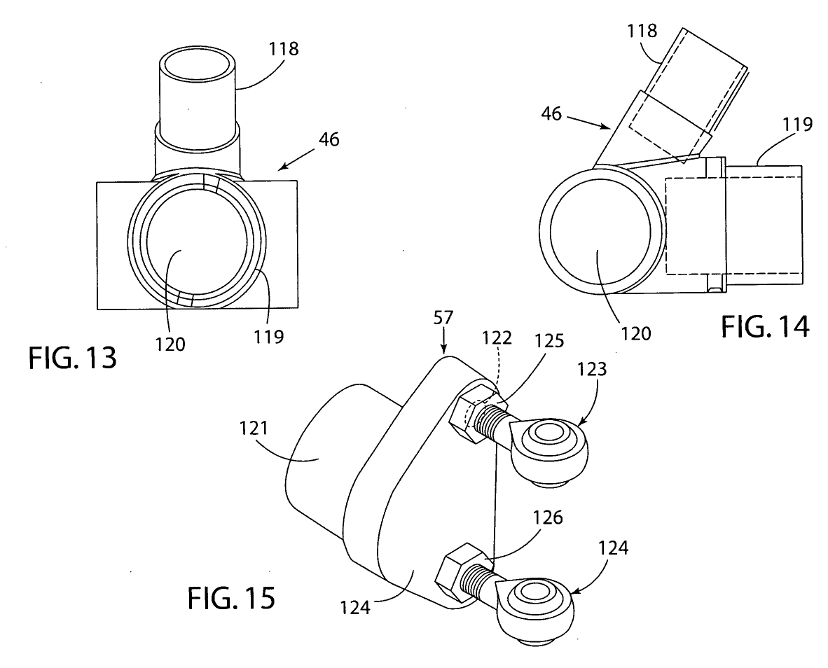

With further reference to FIGS. 13 and 14, front fitting 46 is machined of a 6061 aluminum or other such suitable material, and includes an upper extension 118 that is received in upwardly extending front tube 47, and a rear extension 119 that is received in front tube 44. The fitting 46 is adhesively bonded to the tubes 44 and 47 utilizing Loctite® Hysol® adhesive. A central opening 120 provides for mounting of crank 8 in a substantially conventional manner.

With further reference to FIG. 15, end fitting 57 includes an extension 121 that is received in the outer end of outrigger tube 42 or 43, and is adhesively bonded thereto utilizing Loctite® Hysol® adhesive. (It will be understood that the fittings 57 and 58 are substantially identical.) A pair of openings 122 receive upper and lower ball joints 123 and 124 (see also FIGS. 3 and 4). The ball joints 123 and 124 secure the upper and lower ends of king pins 16 and 17 to fittings 57 and 58. The ball joints 123 and 124 have a threaded end that is received in openings 122, and a stop nut that bears against end surface 124 of fitting 57. The stop nut can be rotated to extend or retract the ball joint relative to end surface 124 to thereby adjust the angle of king pins 16 and 17. In this way, a user can adjust the camber of front wheels 3 and 4 to adapt the trike 1 to a given riding condition. For example, if a rider uses the trike 1 on mountain roads or the like requiring high speed turns, the camber of the front wheels 3 and 4 can be increased to provide additional stability in corners. Alternately, the camber may be reduced to provide for tighter cornering if required for a particular riding condition.

As discussed above, in a preferred embodiment the frame tubes 27, 28, 42, 43, 44, 47, 48 and 49 are made of a carbon fiber composite material. However, the fittings 40, 41, 46, 50, 51, 57 and 58 may also be utilized with metal tubes instead of carbon fiber tubes. For example, some or all of the tubes 27, 28, 42, 43, 44, 47, 48 and 49 may be made of a steel or aluminum material that is adhesively bonded to the fittings 40, 41, 46, 50, 51, 57 and 58. Alternately, the metal tubes may be brazed to interconnect the tubes to the fittings, rather than adhesively bonding the tubing to the fittings. Still further, if the tubes are made of a metal material that is substantially similar to the metal of the fittings, the tubes may be welded to the fittings utilizing a Tig welding process or the like.

The frame construction of the trike 1 provides a frame that is very stiff with respect to side loads caused by cornering and the like due to the parallel, spaced-apart main tubes 27 and 28. However, the frame 2 is somewhat more flexible with respect to vertical loading, such that the frame 2 flexes to absorb bumps on the road surfaces and thereby provide a comfortable ride. The carbon fiber tubes also provide vibration absorption to further reduce the jarring that the rider would otherwise experience.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A human powered three-wheeled vehicle, comprising:
a frame having a forward portion and a rear portion, and at least two side-by-side tubular frame members extending between the forward portion of the frame and the rear portion of the frame;
a pair of front wheels mounted to the frame adjacent the forward portion thereof;
a rear wheel mounted to the frame adjacent the rear portion thereof;
a cog connected to the rear wheel;
a crank including a chain wheel mounted to the frame adjacent the front portion thereof;
a drive chain wrapping around the chain wheel and the cog and extending therebetween and driving the rear wheel upon rotation of the crank;
a seat mounted to the frame for supporting a rider in a recumbent position.

2. The human powered vehicle of claim 1, wherein:
the at least two tubular frame members have substantially the same circular cross-sectional shape.

3. The human powered vehicle of claim 1, wherein:
the tubular frame members extend substantially parallel to one another.

4. The human powered vehicle of claim 1, including:
a pair of tubular outrigger members extending outwardly from the frame adjacent forward ends of the tubular frame members;
the front wheels are mounted to the outrigger members adjacent outer ends thereof.

5. The human powered vehicle of claim 1, wherein:
the tubular frame members are made of a composite material including a polymer matrix and carbon fibers embedded in the matrix.

6. The human powered vehicle of claim 5, wherein:
the frame includes front and rear fittings made of a metallic material, and wherein forward ends of the tubular frame members are adhesively bonded to the front fitting, and rearward ends of the tubular frame members are adhesively bonded to the rear fitting.

7. The human powered vehicle of claim 1, wherein:
the at least two tubular frame members are made of a metallic material, and the frame includes front and rear fittings made of a metallic material, and wherein forward ends of the tubular frame members are adhesively bonded to the front fitting, and rearward ends of the tubular frame members are adhesively bonded to the rear fitting.

8. The human powered vehicle of claim 1, wherein:
at least a first one of the tubular frame members defines an opening at a forward end, an opening at a rearward end, and an internal cavity forming a passageway extending between the opening at the forward end and the opening at the rearward end;
the drive chain forms an elongated loop with a pair of elongated central portions; and wherein:
at least a first one of the elongated portions extends through the opening at the forward and rearward ends of the first tubular frame member and through the passageway defined by the internal cavity of the first tubular frame member.

9. The human powered vehicle of claim 8, including:
an elongated sleeve made of a low friction polymeric material positioned inside the first tubular frame member; and wherein:
the first elongated portion of the drive chain extends through the sleeve.

10. The human powered vehicle of claim 1, wherein:
the seat has a lower portion adjustably mounted to both of the tubular frame members such that the seat is supported at least in part by the tubular frame members, and the fore-aft position of the lower portion of the seat can be adjusted.

11. The human powered vehicle of claim 10, wherein:
the fore-aft position of the lower portion of the seat can be adjusted in infinitesimally small increments.

12. The human powered vehicle of claim 10, including:
a pair of clamps mounting the lower portion of the seat to the tubular frame members, each clamp including a pair of arms forming a C-shaped portion that extends around the tubular frame members, the arms having spaced-apart ends forming a gap, each clamp further including a pivotable lever having a cam surface that tends to draw the ends of the arms together upon rotation of the pivotable lever.

13. The human powered vehicle of claim 10, wherein:
the lower portion of the seat is pivotably mounted to the tubular frame members;
the seat includes a generally horizontal seat portion and a generally upright back portion; and including:
at least one telescoping seat stay extending between the frame and the back portion of the seat to provide tilt adjustment of the seat.

14. The human powered vehicle of claim 1, including:
a steering assembly including first and second king pins pivotably interconnecting the front wheels to the frame and defining a pivot axis;
first and second pairs of upper and lower ball joints interconnecting upper and lower ends, respectively, of the first and second king pins to the frame; and wherein:
at least a selected one of the upper and lower ball joints at each king pin is adjustably interconnected to the frame such that the position of the selected one of the ball joints can be adjusted to thereby adjust the pivot axis of the king pins and adjust the camber of the front wheels.

15. A human powered three-wheeled vehicle, comprising:
a frame having a forward portion, a rear portion, and a central portion having at least two side-by-side tubular frame members extending between the forward portion of the frame and the rear portion of the frame, at least a first one of the tubular frame members defining an elongated internal passageway with openings at forward and rearward end portions of the first one of the tubular frame members;
a pair of front wheels mounted to the frame adjacent the forward portion thereof;
a rear wheel mounted to the frame adjacent the rear portion thereof;
a cog connected to the rear wheel;
a crank including a chain wheel mounted to the frame adjacent the front portion thereof;
a drive chain wrapping around the chain wheel and the cog and extending therebetween and driving the rear wheel upon rotation of the crank;
the elongated loop including first and second elongated chain portions, the first elongated chain portion extending inside the first one of the tubular frame members;
a seat mounted to the frame for supporting a rider in a recumbent position.

16. The human powered vehicle of claim 15, including:
first and second elongated sleeves made of a low-friction material positioned inside the first one of the tubular frame members, and wherein:
the first elongated chain section extends inside a first sleeve, and a second elongated chain section extends inside the second sleeve.

17. The human powered vehicle of claim 15, wherein:
the seat defines a lower portion adjustably connected to the central portion of the frame and providing fore-aft positional adjustment of the lower portion of the seat relative to the central portion of the frame.

18. The human powered vehicle of claim 17, including:
a seat connector pivotably connecting the lower portion of the seat to the central portion of the frame; and
the seat defines a back portion configured to support a user's back, wherein the back portion is adjustably connected to the rear portion of the frame and provides tilt adjustment of the seat about the seat connector.

19. A human powered three-wheeled vehicle, comprising:
a frame having a forward portion and a rearward portion and an elongated center portion extending between the forward and rearward portions of the frame, the central portion of the frame defining a side-to-side bending stiffness about a vertical plane, and a vertical bending stiffness about a horizontal plane wherein the side-to-side bending stiffness is substantially greater than the vertical bending stiffness, the forward portion of the frame including left and right outrigger members extending horizontally outward and defining outer ends;
a pair of front wheels rotatably mounted to the outer ends of the left and right outrigger members, the front wheels being pivotable relative to the frame to provide steering capability;
a rear wheel rotatably mounted to the rear portion of the frame;
a rear drive member connected to the rear wheel;
a crank including a forward drive member mounted to the forward portion of the frame;
an elongated drive member engaging the forward drive member and the rear drive member and moving the rear drive member upon movement of the forward drive member;
a seat mounted to the central portion of the frame for supporting a rider.

20. The human powered vehicle of claim 19, wherein:
the central portion of the frame comprises a pair of side-by-side elongated frame members.

21. The human powered vehicle of claim 20, wherein:
the elongated frame members are tubular.

22. The human powered vehicle of claim 19, wherein:
the forward drive member and the rear drive member comprise cogs; and
the elongated drive member comprises a chain.
